(19) United States
(12) Patent Application Publication
(10) Pub. No.: US 2010/0184630 A1
(43) Pub. Date: Jul. 22, 2010

(54) BREAKING THE RHEOLOGY OF A WELLBORE FLUID BY CREATING PHASE SEPARATION

(76) Inventors: Philip F. Sullivan, Bellaire, TX (US); Gary John Tustin, Sawston (GB); Mark Turner, Cumnor (GB); Stephania Poulis Cruz, Conway, AR (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/354,931

(22) Filed: Jan. 16, 2009

(51) Int. Cl. C09K 8/60; C09K 8/588

(52) U.S. Cl. 507/216; 507/214; 507/211; 507/225

(57) ABSTRACT

Embodiments of this invention relate to compositions and methods of treating a subterranean formation penetrated by a well bore including introducing a Theological polymer into a subterranean formation, introducing a partitioning agent into a subterranean formation and forming a heterogeneous mixture comprising a dispersed Theological polymer-rich phase and a partitioning agent-rich phase, wherein the viscosity of the mixture is lower than the viscosity of the mixture when no partitioning agent is present. Embodiments of this invention relate to compositions and methods of treating a surface in contact with a wellbore and/or a subterranean formation penetrated by a well bore including forming a heterogeneous mixture comprising a dispersed Theological polymer-rich phase and a partitioning agent-rich phase at the surface of the subterranean formation, and introducing the mixture into a subterranean formation, wherein the viscosity of the mixture within the subterranean formation is lower than the viscosity of the mixture when no partitioning agent is present and wherein the viscosity of the mixture within the subterranean formation is lower than the viscosity of the mixture when the mixture is formed at the surface of the subterranean formation.

### BACKGROUND OF THE INVENTION

1. Field of the Invention

This invention relates to methods and fluids used in treating a subterranean formation. In particular, the invention relates to the controlling the rheology of wellbore fluids and in methods of treating subterranean formations.

2. Description of the Related Art

Various types of fluids are used in operations related to the development and completion of wells that penetrate subterranean formations and to the production of gaseous and liquid hydrocarbons from natural reservoirs. These operations include drilling, perforating, fracturing, modifying the permeability, or controlling the production of sand or water. The fluids employed in these operations are known as drilling fluids, completion fluids, work-over fluids, packer fluids, fracturing fluids, stimulation fluids, conformance or permeability control fluids, wellbore cleanout fluids, gravel pack fluids, consolidation fluids, and the like, and are collectively referred to herein as well treatment fluids.

Numerous wellbore operations are performed with viscous fluids that must eventually be “broken” to reduce fluid viscosity. Fluid breaking may take place downhole to promote cleanup, facilitate flowback to surface, or it may occur at surface to help separate solids from fluids for easier disposal.

Many breaker technologies exist for polymeric wellbore treatment fluids, but overwhelmingly these technologies involve somehow degrading the polymeric viscosifier in the fluid. Oxidizing breakers and enzymatic breakers cleave or degrade the polymer that creates viscosity in the first place.

These degradative breakers often accomplish their goal of destroying fluid viscosity but are not entirely satisfactory. Enzyme breakers are expensive, susceptible to storage degradation, and are only useful over a limited temperature range. Oxidative breakers are hazardous in storage and handling and have a very limited effective life in aqueous solution. Both enzyme-based and oxidative breakers degrade the polymer in solution; a method to break the viscosity of a polymer based fluid while retaining the integrity of the polymer is needed. Further, it is desirable to have ways to improve the viscosity control within polymer based systems including systems that utilize water-in-water emulsions.

### SUMMARY OF THE INVENTION

Embodiments of this invention relate to compositions and methods of treating a subterranean formation penetrated by a well bore including introducing a Theological polymer into a subterranean formation, introducing a partitioning agent into a subterranean formation and forming a heterogeneous mixture comprising a dispersed Theological polymer-rich phase and a partitioning agent-rich phase, wherein the viscosity of the mixture is lower than the viscosity of the mixture when no partitioning agent is present. Embodiments of this invention relate to compositions and methods of treating a surface in contact with a wellbore and/or a subterranean formation penetrated by a well bore including forming a heterogeneous mixture comprising a dispersed Theological polymer-rich phase and a partitioning agent-rich phase at the surface of the subterranean formation, and introducing the mixture into a subterranean formation, wherein the viscosity of the mixture within the subterranean formation is lower than the viscosity of the mixture when no partitioning agent is present and wherein the viscosity of the mixture within the subterranean formation is lower than the viscosity of the mixture when the mixture is formed at the surface of the subterranean formation.

### BRIEF DESCRIPTION OF THE DRAWINGS

FIG. 1 is a plot of viscosity as a function of shear rate for consistent concentration of guar with increasing concentration of PEG of an embodiment of the invention. All the datasets in FIG. 1 have the same guar concentration.

FIG. 2 is a plot of viscosity as a function of shear rate for consistent concentration of guar with increasing concentration of surfactant of an additional embodiment of the invention. All the datasets in FIG. 2 have the same guar concentration.

FIG. 3 is a plot of viscosity as a function of surfactant concentration of an additional embodiment of the invention.

FIG. 4 is a plot of viscosity as a function of shear rate at varied pH of another embodiment of the invention.

FIG. 5 is a plot of viscosity as a function of pH with varied compositions of another embodiment of the invention.

### DESCRIPTION OF THE INVENTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited.

In the summary of the invention and this description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors have disclosed and enabled the entire range and all points within the range.

Embodiments of this invention relate to methods and apparatus to form and use a well treatment fluid for treating subterranean formations. In particular, embodiments of the invention relate to the use of water-in-water emulsions to control the rheology of well treatment fluids. Further, embodiments of this invention relate to effectively controlling the viscosity of a fluid based on the presence or concentration of a partitioning or phase-separating agent and on controlling the pH of the fluid.

Adding a second polymer or a surfactant to a well treatment fluid can be used as a way to tailor the viscosity of a polymeric fluid. Indeed, “synergistic blends” of polymers for well service applications are known in the industry and polymer-surfactant systems have also been identified. Embodiments of the present invention tailor the selection of specific phase-separating agents that act as breakers for fluids.

Embodiments of the invention provide a way of reducing the rheology of polymeric treatment fluids through phase separation without degrading the original polymer. In this way, the “break effect” is created by the presence of a phase-separating agent rather than by degrading the polymer. The phase-separating agent can be a very safe and environmentally friendly polymer (e.g., polyethylene glycol) that avoids the hazards and costs associated with oxidizers or enzyme breakers.

Two polymers, upon dissolving in a common solvent, may spontaneously separate into two phases that are each enriched in one of the polymers. When two or more different water soluble polymers are dissolved together in an aqueous medium, it is sometimes observed that the system phase separates into distinct regions or phases. The presence of these regions or phases may also be referred to as a water-in-water emulsion. This separation happens when two polymers at high concentration are each water-soluble but thermodynamically incompatible with each other, such as polyethylene glycol (PEG) and dextran.

The morphology of the de-mixed “emulsion” is related to the relative concentration of the two species. Systems formed with a 50/50 phase volume condition often give rise to bi-continuous phase structures with neither phase being internal or external. Biphasic mixtures formulated away from this bi-continuous condition comprise droplets of one polymer-rich phase dispersed in an external phase enriched with the other polymer. These droplets may be of such a nature that they resemble microspheres or other shapes of consistent composition.

The phase behavior and composition of a mixed system depends on the relative polymer concentrations, the interactive associations between the polymer types, and the affinity of each polymer for the common solvent. Temperature, salinity, pH, and the presence of other molecules in solution can all influence the system polymer-polymer and polymer-solvent interactions. Density differences between phases will occasionally give rise to bulk separation if left undisturbed over time.

This phase separation that arises when incompatible polymers are introduced into a system has been studied in other industries. In the food industry, two-phase aqueous fluids are used to create polymer solutions that mimic the properties of fat globules. In the biomedical industry, such systems are exploited as separation media for proteins, enzymes, and other macromolecules that preferentially partition to one polymer phase in the mixture. For example, drug encapsulation and surface modifiers may be selected that comprise water-in-water emulsions because the nontoxic materials are charged and have moderate interfacial tension between two phases.

The term water-in-water emulsion as used herein is used to encompass mixtures comprising normally water-soluble polymers in the dispersed phase regardless of whether the dispersed phase is a liquid droplet of low or high viscosity polymer solution, or a paste-like or water wet polymer globule containing solid polymer particles, i.e. the water-in-water emulsion is applicable to both liquid-liquid mixtures and liquid-solid slurries comprising water-soluble polymers. Such two-phase systems are variously referred to in the literature as water-in-water emulsions, biphasic systems, aqueous two phase systems (ATPS), gelling polymer fluid, cross-linked microbeads, aqueous/aqueous emulsion system, aqueous biphasic system, low viscosity polymer fluid, filled system, solvent-in-solvent emulsion, or heterogeneous mixture (with a polymer rich phase and a partitioning agent rich phase). Although they may be referred to as emulsions they do not necessarily contain either oil or surfactant.

Water-in-water or other solvent-in-solvent emulsions can be used to deliver polymers, especially rheology modifying polymers, to dense brines and other well treatment fluids. Where the dispersed phase comprises small polymer solution droplets or water-wet polymer particles, the emulsions behave Theologically much like a slurry of hard particles in the continuous phase. Thus, the apparent viscosity of the emulsion is influenced primarily by the rheology of the continuous phase, and not much at all by the viscosity of the dispersed phase.

### Preparing a Composition

Exposing incompatible polymers to each other to form a water-in-water emulsion may occur in the subterranean formation, in a well bore, or at the upper surface of the subterranean formation. A change in viscosity or rheology of the emulsion may occur when the two polymers are in contact with each other in a heterogeneous mixture. The viscosity or rheology of the emulsion may also decrease upon changing the pH or the salinity of the emulsion. Contacting the polymers in the subterranean formation is desirable because a higher viscosity polymer solution (such as a solution containing a rheological polymer) may be used to perform a treatment upon the subterranean formation. Then, upon exposure to the incompatible polymer, the viscosity and rheology of the combined polymers is diminished, facilitating easier post-flush withdrawal of the mixture from the subterranean formation. The viscosity of the heterogeneous mixture may be lower by several orders of magnitude than the mixture if no partitioning agent were present. In some embodiments, the viscosity of the mixture is 20 percent lower than the viscosity of the mixture when no partitioning agent is present.

This diminished rheology or viscosity may be accomplished by introducing the partitioning agent as a preflush or postflush fluid, introducing the rheological agent before or after the partitioning agent or introducing the partitioning agent as an encapsulated or slow release agent. Materials to alter the liquid medium that contains the polymers over time may also be introduced into the subterranean formation, such as pH control agents or salts. These materials may also be encapsulated or slow dissolve or slow release acids, bases, buffers, or salts. Finally, each one of these components may be separately pumped into the subterranean formation. For example, a system using a coiled tubing apparatus may introduce the final component in a post flush treatment to trigger the phase separation and resulting decrease in viscosity or rheology.

In an alternative embodiment, the incompatible polymers may be combined at the upper surface of the subterranean formation in a liquid medium that is selected to encourage the incompatible polymers to be more compatible, that is, to refrain from existing as a water-in-water emulsion until the fluid is in the subterranean formation. One of the polymers may be encapsulated. An additional agent may be introduced such as a pH control agent or a salt and the agent may be encapsulated or in slow release form.

Salts or brines may be used to tailor the viscosity or rheology of a water-in-water emulsion. A preflush containing salt or brine may be introduced into the subterranean formation. The salt or brine may be added to the emulsion at the upper surface of the subterranean formation. The salt or brine may be encapsulated. Alternatively, postflush treatment may be performed that includes salt or brine. The inorganic salts that are particularly suitable include, but are not limited to, water-soluble potassium, sodium, and ammonium salts, such as potassium chloride and ammonium chloride. Additionally, magnesium chloride, calcium chloride, calcium bromide, zinc halide, sodium carbonate, and sodium bicarbonate salts may also be used. Any mixtures of the inorganic salts may be used as well. The presence of inorganic salts may aid in the development of increased viscosity that is characteristic of preferred fluids. Further, the inorganic salt may assist in maintaining the stability of a geologic formation to which the fluid is exposed. Formation stability and in particular clay stability (by inhibiting hydration of the clay) is achieved at a concentration level of a few percent by weight and as such the density of fluid is not significantly altered by the presence of the inorganic salt unless fluid density becomes an important consideration, at which point, heavier inorganic salts may be used. In some embodiments of the invention, the electrolyte is an organic salt such as tetramethyl ammonium chloride, or inorganic salt such as potassium chloride. The electrolyte is preferably used in an amount of from about 0.01 wt % to about 12.0 wt % of the total liquid phase weight, and more preferably from about 0.1 wt % to about 8.0 wt % of the total liquid phase weight.

The well treatment fluid may be prepared by any one of the embodiments of the methods described above, including any combination or permutation of the individual method steps.

### Ratio of Components

The ratio of components selected within the fluid or concentrate may be selected based on a variety of factors. In an embodiment, the mixing step comprises a weight ratio of rheological polymer to partitioning agent from 1:4 to 5:1. Another embodiment of the present invention provides the polymer concentrate prepared by a method described above. In an embodiment, the heterogeneous mixture can include from about 1 to about 60 percent or about 5 to about 20 percent of the Theological polymer, by weight of the water in the mixture.

### Partitioning a Agent

In an embodiment, a partitioning agent may be selected that severely limits the solubility of a rheological agent, such as a polymer. As a result, the mixture forms a water-in-water emulsion where a concentrated Theological agent is concentrated in the dispersed phase, as a viscous aqueous solution or as water-wet, hydrated, or partially hydrated particles, and the partitioning agent is concentrated in the continuous phase. One exemplary, non-limiting system comprises guar as the viscosifying agent and polyethylene glycol (PEG) as the partitioning agent.

The selection of the partitioning agent depends on the polymer that is to be concentrated in the heterogeneous mixture, as well as the solvent system, e.g. aqueous, non-aqueous, oil, etc. In one embodiment in general, the partitioning agent is soluble in the solvent medium, but has dissimilar thermodynamic properties such that a solution thereof is immiscible with a solution of the polymer at concentrations above a binodal curve for the system, or such that a solid phase of the polymer will not dissolve in a solution of the portioning agent at the concentration in the system. For example, where the polymer is a high molecular weight hydrophilic polymer, the partitioning agent can be a low molecular weight hydrophobic polymer. For guar and polymers thermodynamically similar to guar, the partitioning agent in an embodiment is a polyoxyalkylene, wherein the oxyalkylene units comprise from one to four carbon atoms, such as, for example a polymer of ethylene glycol, propylene glycol or oxide, or a combination thereof, having a weight average molecular weight from 1000 to 25,000. As used herein, “polyoxyalkylene” and refers to homopolymers and copolymers comprising at least one block, segment, branch or region composed of oxyalkylene repeat units, e.g. polyethylene glycol. Polyethylene glycol (PEG) having a molecular weight between 2000 and 10,000 is widely commercially available. Other embodiments comprise methoxy-PEG (mPEG); poloxamers available as PEG-polypropylene oxide (PPO) triblock copolymers under the trade designation PLURONICS; alkylated and hydroxyalkylated PEG available under the trade designation BRIJ, e.g. BRIJ 38™; and the like.

Other examples of partitioning agents can include polyvinyl pyrrolidone, vinyl pyrrolidine-vinyl acetate copolymers, and hydroxyalkylated or carboxyalkylated cellulose, especially low molecular weight hydroxyalkylated cellulose such as hydroxypropyl cellulose having a molecular weight of about 10,000.

Another embodiment of partitioning agents comprises the class of water soluble chemicals known as non-ionic surfactants. These surfactants comprise hydrophilic and hydrophobic groups, that is, they are amphiphilic, but are electrophilically neutral, i.e. uncharged. Nonionic surfactants can be selected from the group consisting of alkyl polyethylene oxides (such as BRIJ™ surfactants), polyethylene oxide-polypropylene oxide copolymers (such as poloxamers or poloxamines, for example), alkyl-, hydroxyalkyl- and alkoxyalkyl polyglucosides (such as octyl or decyl glucosides or maltosides), fatty alcohols, fatty acid amides, and the like.

### Rheoloaical or Crosslinkable Polymer

As used herein, when a polymer is referred to as comprising a monomer or comonomer, the monomer is present in the polymer in the polymerized form of the monomer or in the derivative form of the monomer. However, for ease of reference the phrase comprising the (respective) monomer or the like may be used as shorthand.

Some examples of polymers useful in the invention include polymers that are either crosslinked or linear, or any combination thereof. Polymers include natural polymers, derivatives of natural polymers, synthetic polymers, biopolymers, and the like, or any mixtures thereof. An embodiment uses any viscosifying polymer used in the oil industry to form gels. Another embodiment uses any friction-reducing polymer used in the oil industry to reduce friction pressure losses at high pumping rates, e.g. in SLICKWATER™ systems. Some non-limiting examples of suitable polymers include: polysaccharides, such as, for example, guar gums, high-molecular weight polysaccharides composed of mannose and galactose sugars, including guar derivatives such as hydropropyl guar (HPG), carboxymethyl guar (CMG), and carboxymethylhydroxypropyl guar (CMHPG), and other polysaccharides such as xanthan, diutan, and scleroglucan; cellulose derivatives such as hydroxyethyl cellulose (HEC), hydroxypropyl cellulose (HPC), carboxymethlyhydroxyethyl cellulose (CMHEC), and the like; synthetic polymers such as, but not limited to, acrylic and methacrylic acid, ester and amide polymers and copolymers, polyalkylene oxides such as polymers and copolymers of ethylene glycol, propylene glycol or oxide, and the like. In some embodiments, polyacrylamide and copolymers of polyacrylamide may be selected.

The rheological polymers are preferably water soluble. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion- pair association with the polymer resulting in a hydrophobically modified polymer having a plurality of hydrophobic groups, as described United States Patent Application Publication Number 2004209780, which is incorporated by reference herein.

In some cases, the polymer or polymers are formed of a linear, nonionic, hydroxyalkyl galactomannan polymer or a substituted hydroxyalkyl galactomannan polymer. Examples of useful hydroxyalkyl galactomannan polymers include, but are not limited to, hydroxy-C₁-C₄-alkyl galactomannans, such as hydroxy-C₁-C₄-alkyl guars. Preferred examples of such hydroxyalkyl guars include hydroxyethyl guar (HE guar), hydroxypropyl guar (HP guar), and hydroxybutyl guar (HB guar), and mixed C₂-C₄, C₂/C₃, C₃/C₄, or C₂/C₄ hydroxyalkyl guars. Hydroxymethyl groups can also be present in any of these.

As used herein, substituted hydroxyalkyl galactomannan polymers are obtainable as substituted derivatives of the hydroxy-C₁-C₄-alkyl galactomannans, which include: 1) hydrophobically-modified hydroxyalkyl galactomannans, e.g., C₁-C₂₄-alkyl-substituted hydroxyalkyl galactomannans, e.g., wherein the amount of alkyl substituent groups is preferably about 2 percent by weight or less by weight of the hydroxyalkyl galactomannan; and 2) poly(oxyalkylene)-grafted galactomannans (see, e.g., A. Bahamdan & W. H. Daly, in Proc. 8PthP Polymers for Adv. Technol. Int'l Symp. (Budapest, Hungary, September 2005) (PEG- and/or PPG-grafting is illustrated, although applied therein to carboxymethyl guar, rather than directly to a galactomannan)). Poly(oxyalkylene)-grafts thereof can comprise two or more than two oxyalkylene residues; and the oxyalkylene residues can be C₁-C₄ oxyalkylenes. Mixed-substitution polymers comprising alkyl substituent groups and poly(oxyalkylene) substituent groups on the hydroxyalkyl galactomannan are also useful herein. In various embodiments of substituted hydroxyalkyl galactomannans, the ratio of alkyl and/or poly(oxyalkylene) substituent groups to mannosyl backbone residues can be about 1:25 or less, i.e. with at least one substituent per hydroxyalkyl galactomannan molecule; the ratio can be: at least or about 1:2000, 1:500, 1:100, or 1:50; or up to or about 1:50, 1:40, 1:35, or 1:30. Combinations of galactomannan polymers according to the present disclosure can also be used.

As used herein, galactomannans in one embodiment comprise a polymannose backbone attached to galactose branches that are present at an average ratio of from 1:1 to 1:5 galactose branches:mannose residues. Preferred galactomannans comprise a 1→4-linked β-D-mannopyranose backbone that is 1→6-linked to α-D-galactopyranose branches. Galactose branches can comprise from 1 to about 5 galactosyl residues; in various embodiments, the average branch length can be from 1 to 2, or from 1 to about 1.5 residues. Preferred branches are monogalactosyl branches. In various embodiments, the ratio of galactose branches to backbone mannose residues can be, approximately, from 1:1 to 1:3, from 1:1.5 to 1:2.5, or from 1:1.5 to 1:2, on average. In various embodiments, the galactomannan can have a linear polymannose backbone. The galactomannan can be natural or synthetic. Natural galactomannans useful herein include plant and microbial (e.g., fungal) galactomannans, among which plant galactomannans are preferred. In various embodiments, legume seed galactomannans can be used, examples of which include, but are not limited to: tara gum (e.g., from Cesalpinia spinosa seeds) and guar gum (e.g., from Cyamopsis tetragonoloba seeds). In addition, although embodiments of the present invention may be described or exemplified with reference to guar, such as by reference to hydroxy-C₁-C₄-alkyl guars, such descriptions apply equally to other galactomannans, as well.

In embodiments, the rheological polymer can be a polysaccharide; the partitioning agent a polyalkylene oxide. In a particular embodiment, the heterogeneous mixture can comprise polyethylene glycol and one or more of guar, guar derivative, cellulose, cellulose derivative, heteropolysaccharide, heteropolysaccharide derivative, or polyacrylamide in an aqueous medium.

### Additional Fluid Components

In an embodiment, the liquid media can be aqueous and the partitioning agent can include nonionic surfactant. Additionally or alternatively, the method can further comprise the step of dispersing a gas phase in the well treatment fluid to form an energized fluid or foam.

The water-in-water emulsion may further include other additives such as dispersing aids, surfactants, pH adjusting compounds, buffers, antioxidants, colorants, biocides, which do not materially change the miscibility or solubility of the heterogeneous phases, or interfere with the desirable characteristics of the well treatment fluid. The polymer concentrate can include any additive that is to be introduced into the well treatment fluid separately, provided that it is essentially inert in the concentrate. In one embodiment, at least one other well treatment fluid additive is present in the polymer concentrate, such as, for example, proppants, fibers, crosslinkers, breakers, breaker aids, friction reducers, surfactants, clay stabilizers, buffers, and the like. The other additive can also be concentrated in the polymer concentrate so that the additive does not need to be added to the well treatment fluid separately, or can be added in a lesser amount. This can be advantageous where the other additive is usually added proportionally with respect to the polymer. Also, the activity of an additive(s) can be delayed, in one embodiment, and the delay can at least in part be facilitated where the additive is preferentially concentrated in the partitioning agent-rich phase or otherwise reactively separated from the polymer.

Some fluid compositions useful in some embodiments of the invention may also include a gas component, produced from any suitable gas that forms an energized fluid or foam when introduced into an aqueous medium. See, for example, U.S. Pat. No. 3,937,283 (Blauer et al.) incorporated herein by reference. Preferably, the gas component comprises a gas selected from the group consisting of nitrogen, air, argon, carbon dioxide, and any mixtures thereof. More preferably the gas component comprises nitrogen or carbon dioxide, in any quality readily available. The gas component may assist in the fracturing and acidizing operation, as well as the well clean-up process.

The fluid in one embodiment may contain from about 10% to about 90% volume gas component based upon total fluid volume percent, preferably from about 20% to about 80% volume gas component based upon total fluid volume percent, and more preferably from about 30% to about 70% volume gas component based upon total fluid volume percent. In one embodiment, the fluid is a high-quality foam comprising 90 volume percent or greater gas phase. In one embodiment, the partitioning agent used in the polymer delivery system can be selected to enhance the characteristics of the energized fluid or foam, such as gas phase stability or viscosity, for example, where the partitioning agent is a surfactant such as a nonionic surfactant, especially the alkoxylated (e.g., ethoxylated) surfactants available under the BRIJ designation.

In some embodiments, the fluids used may further include a crosslinker. Adding crosslinkers to the fluid may further augment the viscosity of the fluid. Crosslinking consists of the attachment of two polymeric chains through the chemical association of such chains to a common element or chemical group. Suitable crosslinkers may comprise a chemical compound containing a polyvalent ion such as, but not necessarily limited to, boron or a metal such as chromium, iron, aluminum, titanium, antimony and zirconium, or mixtures of polyvalent ions. The crosslinker can be delayed, in one embodiment, and the delay can at least in part be facilitated where the crosslinker or activator is concentrated or otherwise reactively separated in the partitioning agent-rich phase.

### Apparatus

In the fracturing treatment, fluids of the invention may be used in the pad treatment, the proppant stage, or both. The components of the liquid phase are preferably mixed on the surface. Alternatively, a the fluid may be prepared on the surface and pumped down tubing while the gas component could be pumped down the annular to mix down hole, or vice versa.

Yet another embodiment of the invention includes cleanup method. The term “cleanup” or “fracture cleanup” refers to the process of removing the fracture fluid (without the proppant) from the fracture and wellbore after the fracturing process has been completed. The cleanup period of controlled production, generally follows a stimulation treatment, during which time treatment fluids return from the reservoir formation. Depending on the treatment, the cleanup period can be relatively short and uncomplicated. However, following more complex treatments such as gravel packing or hydraulic fracturing, the cleanup process should be conducted carefully to avoid jeopardizing the long-term efficiency of the treatment. Techniques for promoting fracture cleanup traditionally involve reducing the viscosity of the fracture fluid as much as practical so that it will more readily flow back toward the wellbore. While breakers are typically used in cleanup, the fluids described herein may be effective for use in cleanup operations, with or without a breaker.

In another embodiment, the invention relates to gravel packing a wellbore. A gravel packing fluid, it preferably comprises gravel or sand and other optional additives such as filter cake clean up reagents such as chelating agents referred to above or acids (e.g. hydrochloric, hydrofluoric, formic, acetic, citric acid) corrosion inhibitors, scale inhibitors, biocides, leak-off control agents, among others. For this application, suitable gravel or sand is typically having a mesh size between 8 and 70 U.S. Standard Sieve Series mesh.

The procedural techniques for pumping fracture stimulation fluids down a wellbore to fracture a subterranean formation are well known. The person that designs such fracturing treatments is the person of ordinary skill to whom this disclosure is directed. That person has available many useful tools to help design and implement the fracturing treatments, one of which is a computer program commonly referred to as a fracture simulation model (also known as fracture models, fracture simulators, and fracture placement models). Most if not all commercial service companies that provide fracturing services to the oilfield have one or more fracture simulation models that their treatment designers use. One commercial fracture simulation model that is widely used by several service companies is known as FracCADE™. This commercial computer program is a fracture design, prediction, and treatment-monitoring program designed by Schlumberger, Ltd. All of the various fracture simulation models use information available to the treatment designer concerning the formation to be treated and the various treatment fluids (and additives) in the calculations, and the program output is a pumping schedule that is used to pump the fracture stimulation fluids into the wellbore. The text “Reservoir Stimulation,” Third Edition, Edited by Michael J. Economides and Kenneth G. Nolte, Published by John Wiley & Sons, (2000), is an excellent reference book for fracturing and other well treatments; it discusses fracture simulation models in Chapter 5 (page 5-28) and the Appendix for Chapter 5 (page A-15)), which are incorporated herein by reference.

### Additional Considerations

The fluids of some embodiments of the invention may include an electrolyte which may be an organic acid, organic acid salt, organic salt, or inorganic salt. Mixtures of the above members are specifically contemplated as falling within the scope of the invention. This member will typically be present in a minor amount (e.g. less than about 30% by weight of the liquid phase). The organic acid is typically a sulfonic acid or a carboxylic acid, and the anionic counter-ion of the organic acid salts is typically a sulfonate or a carboxylate. Representative of such organic molecules include various aromatic sulfonates and carboxylates such as p-toluene sulfonate, naphthalene sulfonate, chlorobenzoic acid, salicylic acid, phthalic acid and the like, where such counter-ions are water-soluble. Most preferred organic acids are formic acid, citric acid, 5-hydroxy-1-napthoic acid, 6-hydroxy-1-napthoic acid, 7-hydroxy-1-napthoic acid, 1-hydroxy-2-naphthoic acid, 3-hydroxy-2-naphthoic acid, 5-hydroxy-2-naphthoic acid, 7-hydroxy-2-napthoic acid, 1,3-dihydroxy-2-naphthoic acid, and 3,4-dichlorobenzoic acid.

Fluids used in some embodiments of the invention may also comprise an organoamino compound. Examples of suitable organoamino compounds include, but are not necessarily limited to, tetraethylenepentamine, triethylenetetramine, pentaethylenehexamine, triethanolamine, and the like, or any mixtures thereof. When organoamino compounds are used in fluids of the invention, they are incorporated at an amount from about 0.01 wt % to about 2.0 wt % based on total liquid phase weight. Preferably, when used, the organoamino compound is incorporated at an amount from about 0.05 wt % to about 1.0 wt % based on total liquid phase weight. A particularly useful organoamino compound is tetraethylenepentamine, particularly when used with diutan viscosifying agent at temperatures of approximately 300° F.

Breakers may optionally be used in some embodiments of the invention. The purpose of this component is to “break” or diminish the viscosity of the fluid so that this fluid is even more easily recovered from the formation during cleanup. With regard to breaking down viscosity, oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker (the borate anion), will allow the polymer to be crosslinked. Lowering the pH can just as easily eliminate the borate/polymer bonds. At pH values at or above 8, the borate ion exists and is available to crosslink and cause gelling. At lower pH, the borate is tied up by hydrogen and is not available for crosslinking, thus gelation caused by borate ion is reversible. Preferred breakers include 0.1 to 20 pounds per thousands gallons of conventional oxidizers such as ammonium persulfates, live or encapsulated, or potassium periodate, calcium peroxide, chlorites, and the like. In oil producing formations the film may be at least partially broken when contacted with formation fluids (oil), which may help de-stabilize the film. The breaker can be delayed, in one embodiment, and the delay can at least in part be facilitated where the breaker or breaker activator is concentrated or otherwise reactively separated in the partitioning agent-rich phase.

A fiber component may be included in the fluids used in the invention to achieve a variety of properties including improving particle suspension, and particle transport capabilities, and gas phase stability. Fibers used may be hydrophilic or hydrophobic in nature, but hydrophilic fibers are preferred. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in fluids of the invention, the fiber component may be included at concentrations from about 1 to about 15 grams per liter of the liquid phase of the fluid, preferably the concentration of fibers are from about 2 to about 12 grams per liter of liquid, and more preferably from about 2 to about 10 grams per liter of liquid.

Embodiments of the invention may use other additives and chemicals that are known to be commonly used in oilfield applications by those skilled in the art. These include, but are not necessarily limited to, materials in addition to those mentioned hereinabove, such as breaker aids, oxygen scavengers, alcohols, scale inhibitors, corrosion inhibitors, fluid-loss additives, bactericides, iron control agents, organic solvents, and the like. Also, they may include a co-surfactant to optimize viscosity or to minimize the formation of stabilized emulsions that contain components of crude oil, or as described hereinabove, a polysaccharide or chemically modified polysaccharide, natural polymers and derivatives of natural polymers, such as cellulose, derivatized cellulose, guar gum, derivatized guar gum, or biopolymers such as xanthan, diutan, and scleroglucan, synthetic polymers such as polyacrylamides and polyacrylamide copolymers, oxidizers such as persulfates, peroxides, bromates, chlorates, chlorites, periodates, and the like. Some examples of organic solvents include ethylene glycol monobutyl ether, isopropyl alcohol, methanol, glycerol, ethylene glycol, mineral oil, mineral oil without substantial aromatic content, and the like.

Embodiments of the invention may also include placing proppant particles that are substantially insoluble in the fluids. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it will typically be from about 20 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and will preferably be in the range of from about 0.05 to about 3 kilograms of proppant added per liter of liquid phase. Also, any of the proppant particles can further be coated with a resin to potentially improve the strength, clustering ability, and flow back properties of the proppant.

Conventional propped hydraulic fracturing techniques, with appropriate adjustments if necessary, as will be apparent to those skilled in the art, are used in some methods of the invention. One preferred fracture stimulation treatment according to the present invention typically begins with a conventional pad stage to generate the fracture, followed by a sequence of stages in which a viscous carrier fluid transports proppant into the fracture as the fracture is propagated. Typically, in this sequence of stages the amount of propping agent is increased, normally stepwise. The pad and carrier fluid can be a fluid of adequate viscosity. The pad and carrier fluids may contain various additives. Non-limiting examples are fluid loss additives, crosslinking agents, clay control agents, breakers, iron control agents, and the like, provided that the additives do not affect the stability or action of the fluid.

The following examples are presented to illustrate the preparation and properties of specific examples of embodiments of the invention, and should not be construed to limit the scope of the invention, unless otherwise expressly indicated in the appended claims. All percentages, concentrations, ratios, parts, etc. are by weight unless otherwise noted or apparent from the context of their use.

### EXAMPLES

The following examples are presented to illustrate the preparation and properties of fluid systems, and should not be construed to limit the scope of the invention, unless otherwise expressly indicated in the appended claims. All percentages, concentrations, ratios, parts, etc. are by weight unless otherwise noted or apparent from the context of their use.

### Example 1

### PEG as a Breaker for Linear Guar

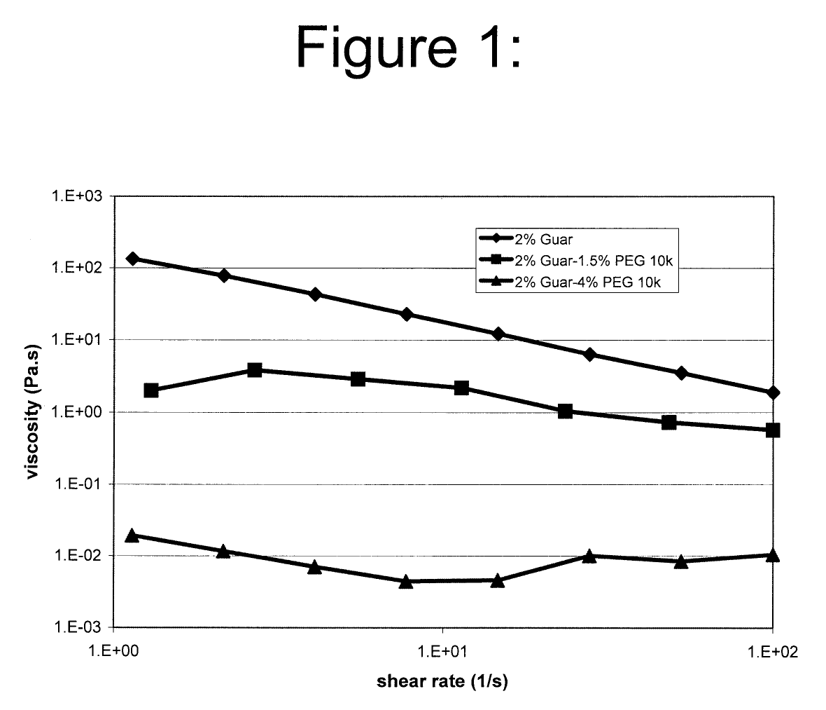

This example demonstrates the ability of polyethylene glycol (PEG 10000 molecular weight) to serve as a breaker for 2.0 weight percent linear guar. A series of fluid samples were made by dissolving guar (approximately 2 million molecular weight from Rhodia) in DI water for 60 minutes to assure complete dissolution and hydration of the polymer. Different concentrations of PEG were added to a series guar solution samples, mixed for approximately ten minutes, and then observed. For additions of PEG above a concentration of approximately 1.5 wt %, the PEG polymer serves as a phase-separating agent to change the fluid from a highly viscous single phase solution to a low-viscosity two-phase fluid. Significant changes in viscosity were observed for samples in which the fluid has become phase-separated, as illustrated in FIG. 1. Here, the rheology of each sample was measured over a range of shear rates from approximately 1 s⁻¹ to 100 s⁻¹ at a temperature of 25° C. At the onset of phase separation (1.5% PEG), the low shear rheology of the sample has been decreased by more than one order of magnitude. For higher concentrations of PEG, the break effect is further enhanced, with FIG. 1 showing a low shear viscosity decline of almost 4 orders of magnitude with the addition of 4% PEG. The conclusion that may be drawn from this example is that addition of a phase separating agent (PEG in this example) serves as a breaker for reducing the rheology of the guar solution.

### Example 2

### Surfactant as a Phase-Separating Breaker for Guar in Solution

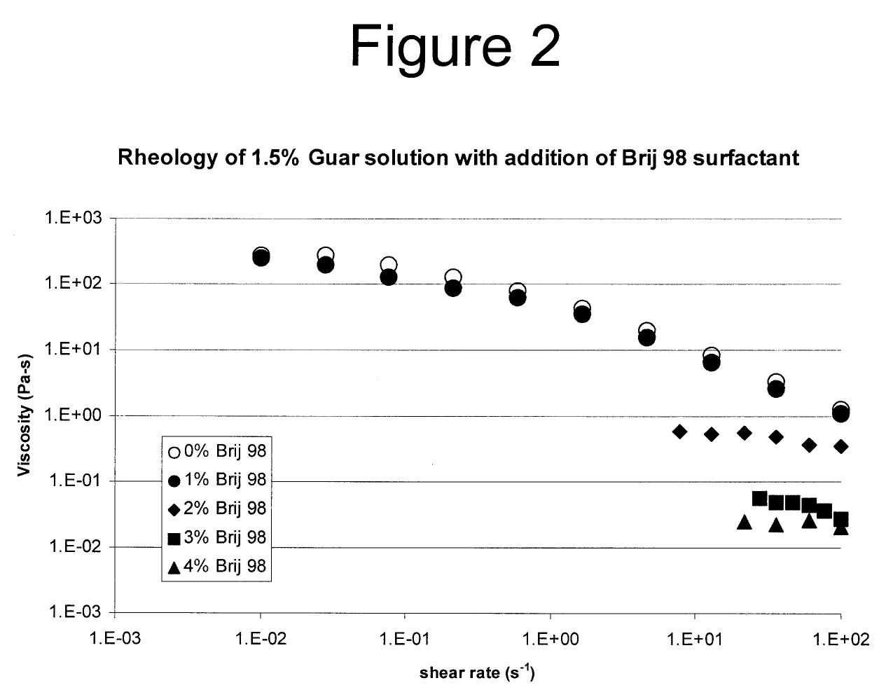

Although the phase separating agent in Example 1 was a polymer (PEG10000), this approach is not limited to polymers. In this example, a concentrated guar solution is broken by addition of a surfactant (BRIJ 98™) that acts as the phase separating agent. For a polymer solution of 1.5 weight percent guar, addition of up to approximately 1 weight percent BRIJ 98™ does not significantly impact the solution viscosity and the solution is observed to remain single phase and viscous (FIG. 2). However, further addition results in phase separation and commensurate break of the fluid rheology. Samples made with 2%, 3%, and 4% BRIJ 98™ are phase separated and very low viscosity. Measurements in FIG. 2 indicate the rheology of these samples is Newtonian—as one would expect for a polymer solution that no longer percolate across the sample volume.

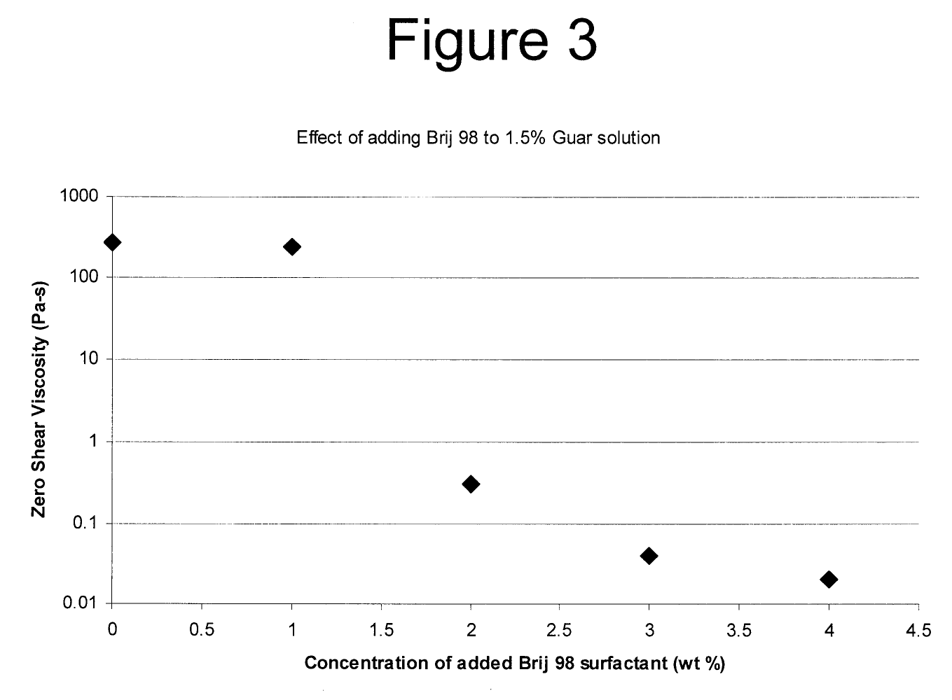

FIG. 3 summarizes the break behavior of BRIJ 98™ on 1.5 weight percent guar by plotting the approximate zero shear viscosity as a function of BRIJ 98 concentration in solution. Addition of 2% BRIJ 98™ has decreased the zero shear rheology by almost three orders of magnitude and even further breaking is accomplished by increasing the BRIJ 98™ surfactant higher.

### Example 3

### Use of Phase Separation to Make Salt-Triggerable or pH-Triggerable Breaker Systems

Polyelectrolytes in solution do not readily phase separate unless the charged entities on the polymer are somehow neutralized. Because of this effect, it is possible to formulate a fluid with a phase-separating agent that is not effective (“hidden”) until some other condition has changed. The following examples demonstrate how this combination of factors can take a polymer solution that would not normally break with a change of pH or salinity and create a formulation that drastically loses viscosity as a function of pH or salinity.

A 5 million molecular weight polyacrylamide with a hydrolysis level of approximately 10% is selected. Because of the polyacrylic acid functionality on the polymer, it does not phase separate with addition of PEG at neutral pH. A combined fluid of the polyacrylamide and PEG will phase separate, however, if the pH is decreased to approximately 3.

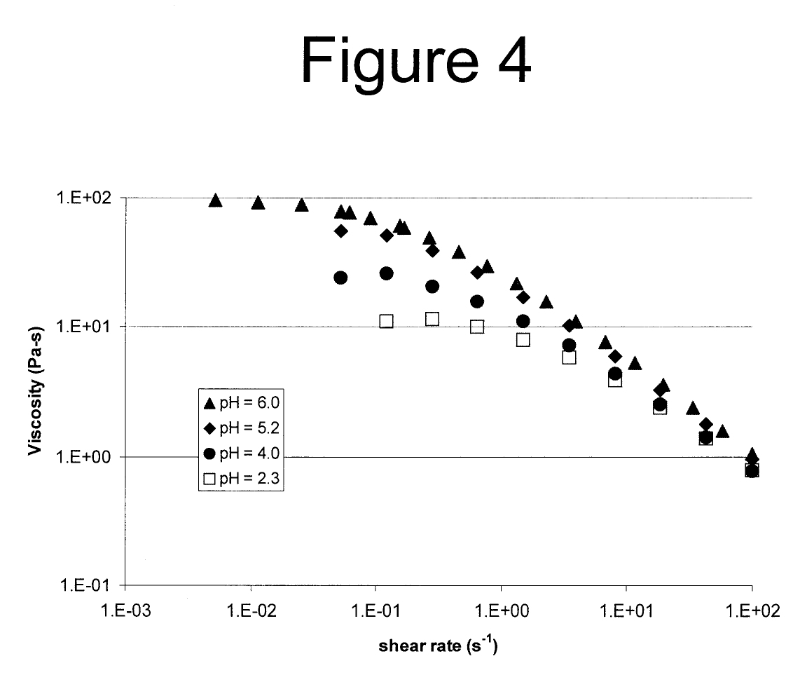

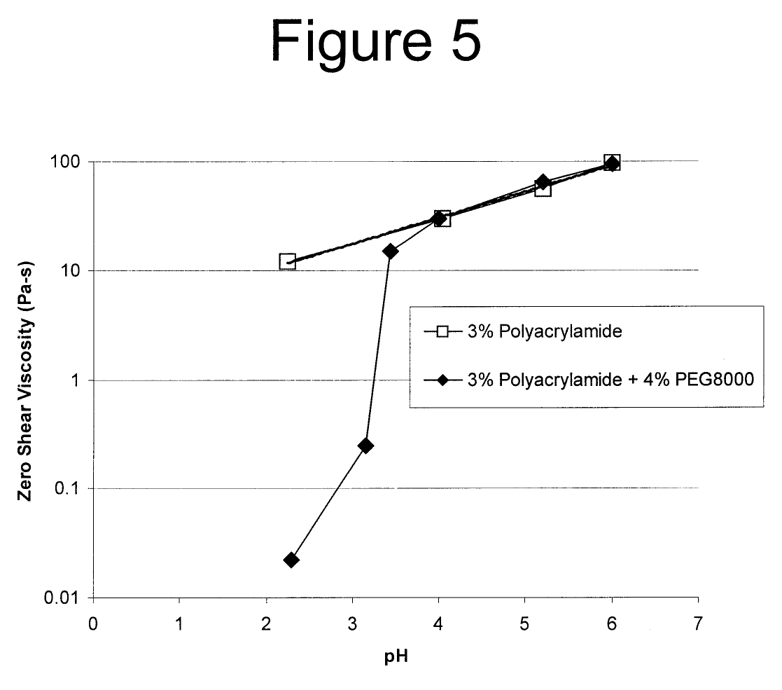

The rheology of polyacrylamide is pH sensitive because of the charged groups along the polymer. This is illustrated in FIGS. 4 and 5 where the rheology of 3% polyacrylamide dissolved in DI water is shown as a function of pH. In each of these measurements, the polymer has been dissolved in DI water for a minimum of 30 minutes, and pH has been changed by addition of small amounts (drops) of 37% HCl solution. As expected, the rheology of the polymer solution decreases as the pH is decreased because of the protonization of the charged groups along the polymer. Without these charged groups the polymer in solution changes its configuration to a smaller radius of gyration with a commensurate decrease in viscosity.

As shown in FIG. 5, the change in rheology with a drop in pH is dramatically different if a phase-separating agent such as PEG is present in conjunction with the polyacrylamide. Solutions with both polymers readily phase separate to become low viscosity mixtures for pH values less than about 3. This behavior of “hidden phase separating agents” that do not break the fluid rheology until a certain condition pH in this example—is illustrated by FIG. 5. Similar curves result when observing comparable incompatible polymer combinations that are controlled for pH or salinity.

It should be noted that the change in pH to trigger phase separation and rheology breaking can be achieved by releasing acid from an encapsulated particle or from hydrolysis of a solid acid such as polyglycolic acid or polylactic acid.

The particular embodiments disclosed above are illustrative only, as the invention may be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of treating a surface in contact with a wellbore and/or a subterranean formation penetrated by a well bore, comprising:
introducing a rheological polymer into a subterranean formation;
introducing a partitioning agent into a subterranean formation; and
forming a heterogeneous mixture comprising a dispersed Theological polymer-rich phase and a partitioning agent-rich phase,
wherein the viscosity of the mixture is lower than the viscosity of the mixture when no partitioning agent is present.

2. The method of claim 1, wherein the forming a mixture comprises a weight ratio of the rheological polymer to the partitioning agent from 1:4 to 5:1.

3. The method of claim 1, wherein the heterogeneous mixture comprises from about 1 to about 60 percent by weight rheological polymer based on a weight of a liquid media in the heterogeneous mixture.

4. The method of claim 1, wherein the partitioning agent comprises polyethylene glycol, methyl polyethylene glycol, hydroxypropylcellulose, or a combination thereof.

5. The method of claim 1, wherein the rheological polymer comprises guar, guar derivative, cellulose, cellulose derivative, heteropolysaccharide, heteropolysaccharide derivative, polyacrylamide, or a combination thereof.

6. The method of claim 1, wherein the viscosity of the mixture is 20 percent lower than the viscosity of the mixture when no partitioning agent is present

7. The method of claim 1, wherein the rheological polymer retains more molecular integrity than if no partitioning agent were present.

8. The method of claim 1, wherein the partitioning agent is encapsulated or slow release.

9. The method of claim 1, wherein the partitioning agent is a surfactant.

10. The method of claim 1, further comprising controlling the pH of the mixture to reduce the viscosity of the mixture.

11. The method of claim 10, further comprising introducing a pH control agent into the mixture.

12. The method of claim 11, further comprising using the mixture to remove sand from the subterranean formation before introducing a pH control agent into the mixture.

13. The method of claim 11, wherein the pH control agent is a buffer, an acid, or a base.

14. The method of claim 11, wherein the pH control agent is encapsulated or slow release or solid or a combination thereof.

15. The method of claim 10, wherein the pH is controlled to a pH of about 6 or lower.

16. The method of claim 1, further comprising controlling the salinity of the mixture to reduce the viscosity of the mixture.

17. The method of claim 16, wherein the salinity is controlled by introducing a salt or a brine or a combination thereof into the subterranean formation.

18. The method of claim 17, wherein the salt or brine comprises a water soluble salt that comprises sodium, potassium, ammonium, or a combination thereof.

19. The method of claim 17, wherein the salt or brine is encapsulated.

20. The method of claim 17, wherein the salt is slow release or solid or a combination thereof.

21. A method of treating a surface in contact with a wellbore and/or a subterranean formation penetrated by a well bore, comprising:
forming a heterogeneous mixture comprising a dispersed Theological polymer-rich phase and a partitioning agent-rich phase at the surface of the subterranean formation; and
introducing the mixture into a subterranean formation;
wherein the viscosity of the mixture within the subterranean formation is lower than the viscosity of the mixture when no partitioning agent is present and
wherein the viscosity of the mixture within the subterranean formation is lower than the viscosity of the mixture when the mixture is formed at the surface of the subterranean formation.

22. The method of claim 21, wherein the heterogeneous mixture comprises from 2 to 20 percent by weight Theological polymer based on a weight of a liquid media in the heterogeneous mixture.

23. The method of claim 21, wherein the partitioning agent comprises polyethylene glycol, methyl polyethylene glycol, hydroxypropylcellulose, or a combination thereof.

24. The method of claim 21, wherein the rheological polymer comprises guar, guar derivative, cellulose, cellulose derivative, heteropolysaccharide, heteropolysaccharide derivative, polyacrylamide, or a combination thereof.

25. The method of claim 21, wherein the viscosity of the mixture is 20 percent lower than the viscosity of the mixture when no partitioning agent is present

26. The method of claim 21, wherein the partitioning agent is encapsulated or slow release.

27. The method of claim 21, wherein the partitioning agent is a surfactant.

28. The method of claim 21, further comprising controlling the pH of the mixture to reduce the viscosity of the mixture.

29. The method of claim 28, further comprising introducing a pH control agent into the mixture.

30. The method of claim 29, further comprising using the mixture to remove sand from the subterranean formation before introducing a pH control agent into the mixture.

31. The method of claim 29, wherein the pH control agent is a buffer, an acid, or a base.

32. The method of claim 29, wherein the pH control agent is encapsulated or slow release or solid or a combination thereof.

33. The method of claim 28, wherein the pH is controlled to a pH of about 6 or lower.

34. The method of claim 21, further comprising controlling the salinity of the mixture to reduce the viscosity of the mixture.

35. The method of claim 34, wherein the salinity is controlled by introducing a salt or a brine or a combination thereof into the subterranean formation.

36. The method of claim 35, wherein the salt or brine comprises a water soluble salt that comprises sodium, potassium, ammonium, or a combination thereof.

37. The method of claim 35, wherein the salt or brine is encapsulated.

38. The method of claim 35, wherein the salt is slow release or solid or a combination thereof.
